(19) United States
(12) Patent Application Publication
(10) Pub. No.: US 2006/0200360 A1
(43) Pub. Date: Sep. 7, 2006

(54) Online auction of leads

(76) Inventor: Aleksey Razletovskiy, Anaheim, CA (US)

Correspondence Address: STETINA BRUNDA GARRED & BRUCKER, 75 ENTERPRISE, SUITE 250, ALISO VIEJO, CA, 92656, US

(21) Appl. No.: 11/073,159

(22) Filed: Mar. 4, 2005

(51) Int. Cl. G06Q 99/00

(52) U.S. Cl. 705/1

(57) ABSTRACT

A method of directing a service provider to a prospective client is provided. The method comprises the steps of providing a lead category, receiving bids from at least one service providers to purchase leads categorizable under the lead category, and receiving a lead of a prospective client categorizable under the lead category after the receiving bids step. Also, the method may further comprise the step of routing the received lead to the service provider with the highest bid and/or routing the contact information of the service provider with the highest bid to the prospective client.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention relates to online auctioning of leads of prospective clients.

Many businesses purchase leads of prospective clients to increase sales and profitability. These leads may be obtained by lead sellers who attract leads by advertising the fact that they are in the business of directing service providers to prospective clients. Lead sellers utilize websites to promote their services. Typically, these websites collect leads and, in turn, offer them to various service providers such that the service providers may compete for the leads. Unfortunately, the above-described prior art system for directing service providers to prospective clients suffers from several deficiencies that detract from its overall utility. For example, the period of time starting from the point at which the prospective client submits a request for a service provider until the time at which the prospective client receives the contact information of the service provider is quite long and may take up to one or more days. During this time period, the prospective client may have found an alternative service provider through other means such that the prospective client no longer needs the lead seller to be directed to a service provider.

Another deficiency associated with the prior art systems is that other lead sellers may sell leads to various service providers at the lead seller's normal price. In this way, as the leads are collected, the lead sellers may immediately direct the service provider to the prospective client. The lead seller may raise or lower the seller's normal price based on their backlog of leads or on other internal factors. Unfortunately, the seller's normal price may be above or below the fair market value of the leads. As such, service providers may be paying more than the fair market value for the leads which ultimately reduces the service provider's profitability. In addition, the lead sellers may be receiving less than the fair market value for the leads reducing the lead seller's profitability.

Accordingly, there is a need for an improved method and apparatus for directing service providers to prospective clients.

### BRIEF SUMMARY OF THE INVENTION

The present invention addresses the above-described deficiencies as well as other deficiencies associated with the prior art. In an aspect of the present invention, lead categories are auctioned to a plurality of service providers. The service providers compete with each other to purchase future leads that are categorizable under a specific lead category. For example, service providers may bid via an auction format for the lead category relating to prospective clients desiring to purchase residential real estate. In this case, if at some future time, a lead clearinghouse collects a lead for a prospective client who desires to purchase residential real estate, the clearinghouse may immediately direct the prospective client to the highest bidding service provider for such lead category. In this way, the turn-around-time for directing a service provider to the perspective client is reduced or altogether eliminated. Another advantage of such a system is that the purchase price for the lead is set at the fair market value because the purchase price was set by market participants.

The service providers may bid for the lead category through a system of filters. These filters are parameters that are set by the service providers. Such parameters may specify the lead category, the bid price per lead as well as other pertinent information. Once the filter parameters have been entered into the clearinghouse's computer system, the service provider may view a “My Filter” screen of the computer system to determine whether they are a winning bidder or whether they must increase their bid price. In a preferred embodiment, winning bids may be shown in a green color on the “My Filter” screen and losing bids may be shown in a red color on the “My Filter” screen.

Prospective clients may submit a service quote request. In submitting the service quote request, each prospective client may specify their contact information such that service provider(s) may contact them. Also, each prospective client may specify which type of service quote they are requesting. For example, a prospective client may specify that they are requesting real estate agents who represent buyers of residential real estate.

After the service providers have bid for the lead categories and prospective clients have submitted their service quote request, the respective information of both the prospective clients and appropriate service providers may be exchanged such that each party may contact one another for the purpose of consummating a business transaction. In other words, the prospective client is directed to the highest bidding service provider. For example, the service provider may be sent an email with the contact information of the prospective client and the contact information of the service provider may be displayed on a computer screen to the prospective client. Alternatively, only the contact information of the service provider is sent to the prospective client and the contact information of the prospective client is not transmitted to the service provider.

### BRIEF DESCRIPTION OF THE DRAWINGS

These as well as other features of the present invention will become more apparent upon reference to the drawings wherein:

FIG. 1 is a schematic diagram of a method by which leads are generated by websites and affiliates, routed to a database and a call center, and sold to service providers;

FIG. 2 is a first step of three steps by which a prospective client submits a service quote request;

FIG. 3 is a second step of the three steps for submitting the service quote request;

FIG. 4 is a third step of the three steps for submitting the service quote request;

FIG. 5 is an illustration of a processed service quote request;

FIG. 6 is a printout of a webpage summarizing filters of a service provider;

FIG. 7 is a first step of four steps by which a service provider defines filter parameters;

FIG. 8 is a second step of the four steps for defining filter parameters and illustrates that the service provider may narrow the geographical target by state, county, city and zip codes;

FIG. 9 is a continuation of the second step of FIG. 8 and illustrates that the service provider may further narrow the geographical target by selecting desired counties in the selected states;

FIG. 10 is a continuation of the second step of FIG. 8 and illustrates that the service provider may further narrow the geographical target by selecting desired cities in the selected counties;

FIG. 11 is a continuation of the second step of FIG. 8 and illustrates that the service provider may further narrow the geographical target by selecting desired zip codes in the selected counties;

FIG. 12 is a third step of the four steps for defining filter parameters and illustrates that the service provider may select the type of real estate leads and the time period during which the lead was submitted;

FIG. 13 is a fourth step of the four steps for defining filter parameters and illustrates that the service provider may set up an email autoresponder which is emailed to prospective clients if the service provider is directe to the prospective client; and

FIG. 14 is a diagram of a plurality of service providers being directed to a plurality of prospective clients.

### DETAILED DESCRIPTION OF THE INVENTION

The drawings referred to herein are for the purposes of illustrating the various aspects of the present invention and are not meant to limit the scope of the present invention. For example, although the various aspects of the present invention will be discussed in relation to real estate leads, the various aspects of the present invention may be variously embodied and employed with respect to other types of leads including but not limited to mortgage leads, automotive leads, business leads, construction leads, debt recovery leads and insurance leads.

In an aspect of the present invention, lead categories are auctioned to the highest bidder before the leads are generated. The benefit is that the highest bidding service provider purchases the leads at the fair market value at the time the lead is generated, and the leads clearinghouse sells the leads at the fair market value at the time the lead is generated. Another benefit of the present invention is that the turn-around-time for the clearinghouse to direct a service provider to the prospective client is reduced by performing the auctioning step before the lead is generated (i.e., before the prospective client requests contact information of service providers). In this way, the time for the prospective client to receive contact information of a service provider(s) is reduced and possibly eliminated. For example, the prospective client may immediately be provided contact information for one or more service providers upon submission of certain basic information relating to the type of service desired by the prospective client.

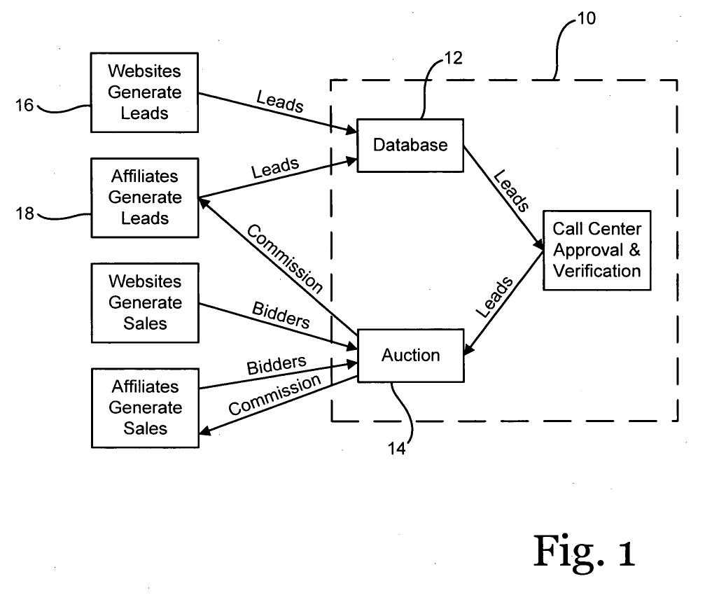

Referring now to FIG. 1, in an aspect of the present invention, the clearinghouse 10 may collect leads from a variety of sources and store the leads in a database 12. Also, the clearinghouse may operate an online auction 14 of lead categories such that the leads may be distributed to the highest bidding service provider(s) as the leads are generated/collected. As such, the clearinghouse 10 may both generate the leads and auction lead categories to various service providers. The clearinghouse 10 may generate the leads through their own internet website 16. For example, the clearinghouse 10 may advertise via radio, television and billboards that contact information of various service providers may be obtained at their website. Prospective clients may view the clearinghouse's website 16 on the internet and submit an online request for service providers to contact them. At this point, a lead is generated. The clearinghouse 10 then determines the appropriate lead category of the generated lead. The clearinghouse 10 matches the then highest bidding service provider of the determined lead category with the prospective client by sending the prospective client's contact information to the highest bidding service provider(s) and/or sending the service provider's contact information to the prospective client. Because the lead category was auctioned before the lead is generated, the prospective client does not have to wait for the clearinghouse 10 to offer and sell the generated lead to service providers. Hence, the elapsed time from the time of request to the time contact information is presented to the prospective client is reduced by the time required for the clearinghouse 10 to offer and sell the generated lead.

The clearinghouse 10 may generate the leads by directing web traffic toward the clearinghouse's website 16 by advertising on television, radio, billboard and other advertisement media regarding the existence of such website 16. Additionally, the clearinghouse 10 may form an affiliate program 18 in which other entities are given a percentage of profits generated by those leads generated by the affiliate. The affiliate merely funnels the affiliate's leads to the clearinghouse 10 while the clearinghouse 10 offers and sells the affiliate's leads and pays the affiliate a percentage of profits or revenue derived from the affiliate's leads. Affiliates may generate leads through the normal course of their business. For example, if their customer(s) requests a product which is collateral to the affiliate's main business and the affiliate does not offer such product for sale, then the affiliate may submit their customer's contact information and customer's request to the clearinghouse 10. Additionally, affiliates may generate leads by operating a website that collects leads. The clearinghouse 10 may support the affiliate by providing the affiliate with a website having substantially the same content as the clearinghouse's website 16 except that the affiliate's name may be displayed on the website 16 such that prospective clients are lead to believe that the website 16 is operated by the affiliate and not the clearinghouse 10.

In an aspect of the present invention, as shown in FIG. 1, leads may be sold to service providers through the clearinghouse's website 16 or through the affiliate program 18. If they are sold through the affiliate program 18, then the affiliate may receive a percentage of such revenue. The auction 14 for the leads occurs before the leads are generated. In other words, a plurality of service providers may bid for lead categories such that leads that are categorizable under the lead category may be directed to the highest bidding service provider(s). Once the auction 14 is complete, then as the leads are generated, they may be directed to the highest bidding service provider(s).

As shown in FIG. 1, the leads may be generated via the clearinghouse's website 16 or through the affiliate program 18. These leads may then be collected at a central database 12. For those leads generated through the affiliate program 18, the affiliate may receive a percentage of any revenue derived from their leads. Once the leads are stored in the central database 12, the clearinghouse 10 may contact the prospective client via the call center 20 to verify their contact information (if there are bids for verified leads (see discussion below on verified leads)). At this point, the leads are available for sale. The leads are categorized and directed to the highest bidding service provider(s) determined by the auction 14. Since the auction 14 has already taken place, the leads may be immediately directed to the prospective client without having to offer the lead to a plurality of service providers and sell the lead to the highest winning service provider. Simply put, service providers are placed in contact with prospective clients faster, and the price for the leads are at the fair market value such that service providers are not overpaying for the lead and the clearinghouse 10 is not underselling the lead.

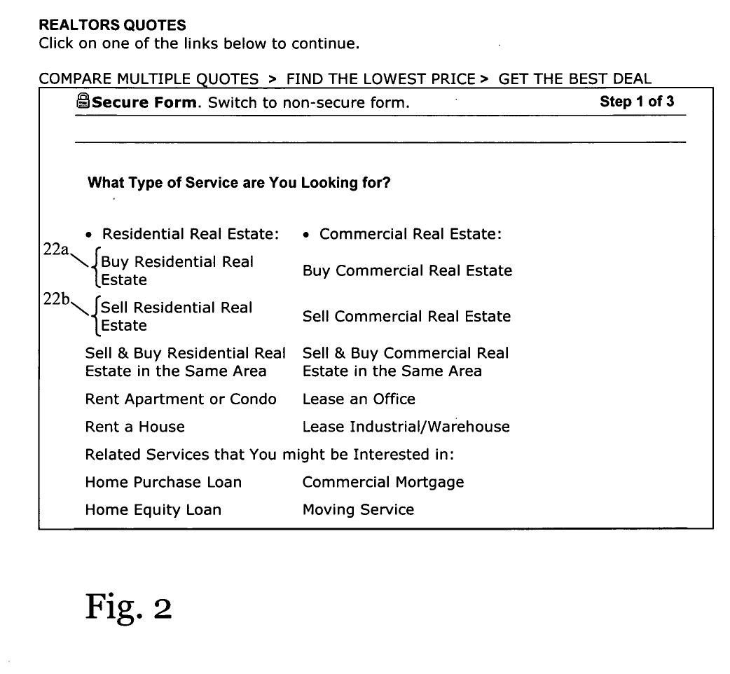

In another aspect of the present invention, an example of the clearinghouse's website 16 which generates leads is shown in FIGS. 2-5. As will be discussed in further detail below, the prospective client should submit two different types of information to request contact information of service providers. First, the prospective client must provide his/her contact information. Second, the prospective client must provide parameters of the request. In particular, the first webpage (not shown) may provide the prospective client with a list of choices to select the general type of service provider in which they may be interested. For example, the prospective client may be interested in real estate service providers, mortgage services providers, etc. Such choices may be characterized as defining the prospective client's general parameters of the request. In addition, if the prospective client is interested in the general field of real estate, then the prospective client may also be provided with a breakdown of the various types of service providers within the general category of real estate such as “Buy Residential Real Estate” 22a, “Sell Residential Real Estate” 22b, etc., as shown in FIG. 2. Such choices may be characterized as defining the prospective client's specific parameters of the request.

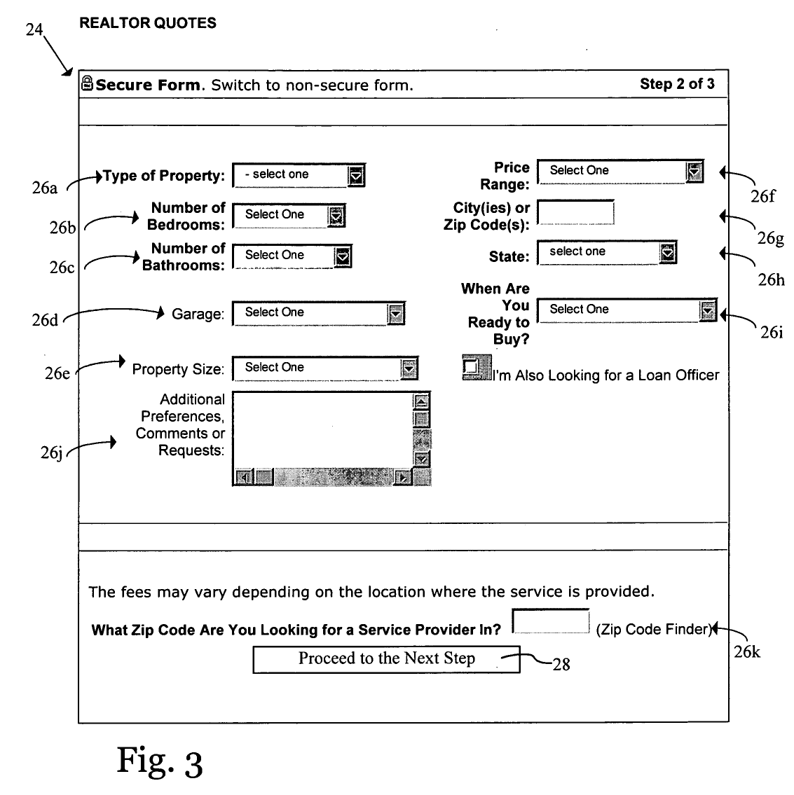

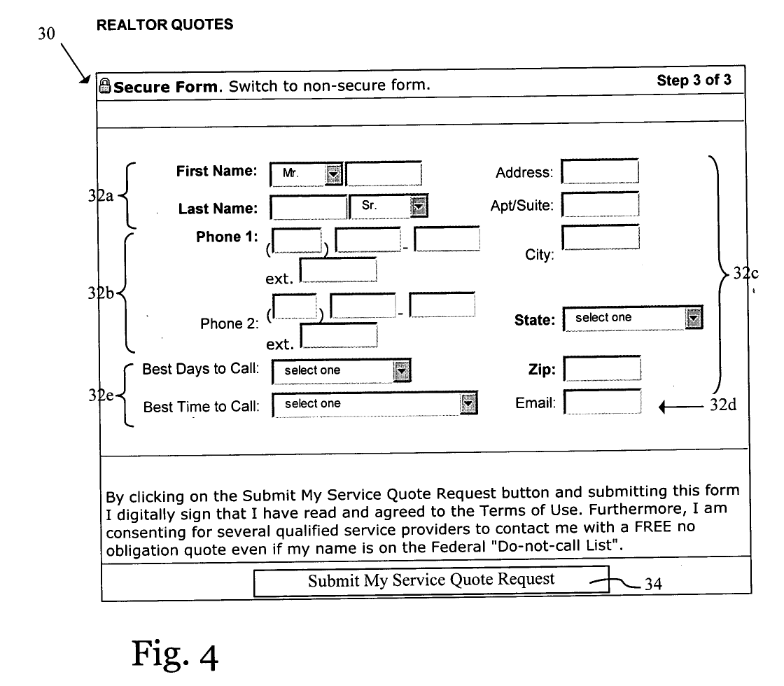

FIG. 3 illustrates a form 24 on the webpage if the “Buy Residential Real Estate” link 22a shown in FIG. 2 is selected. In particular, the form 24 shown in FIG. 3 queries the prospective client regarding the type of residential property they want to purchase which may include and which are mentioned here by way of example and not limitation, the type of property (e.g., single family home, condominium, etc.) 26a, number of bedrooms (e.g., one or more, two or more, etc.) 26b, number of bathrooms (e.g., 1 or more, 1.5 or more, etc.) 26c, garage size (e.g., 1 car attached, 1 car detached, etc.) 26d, property size (e.g., 500-1,000 sq. ft., 1,000-1,500 sq. ft., etc.) 26e, price range (e.g., $400,000-$500,000, $500,000-$600,000, etc.) 26f, cities and/or zip codes 26g, state 26h, the time frame for purchasing a home (e.g., immediately, within the next two months, etc.) 26i, and other comments 26j. The form also allows the prospective client to receive contact information of service providers in particular zip codes 26k. Each of the fields above 24a-24k may be a fill-in field or a drop-down list of options for the prospective client to fill in or select. After the prospective client fills out the form 24, the prospective client may select the “Proceed to the Next Step” option or button 28 which then prompts the prospective client to input his/her contact information, as shown in FIG. 4. This form 30 specifically prompts the prospective client to enter the his/her first and last name 32a, phone number 32b, address 32c, email address 32d, and the best time and day to call 32e. Thereafter, the prospective client may select the “Submit My Service Quote Request” option or button 34. At this point the clearinghouse 10 has generated a lead. The lead is stored in the database 12 and is directed to the highest bidding service provider as determined by the auction 14.

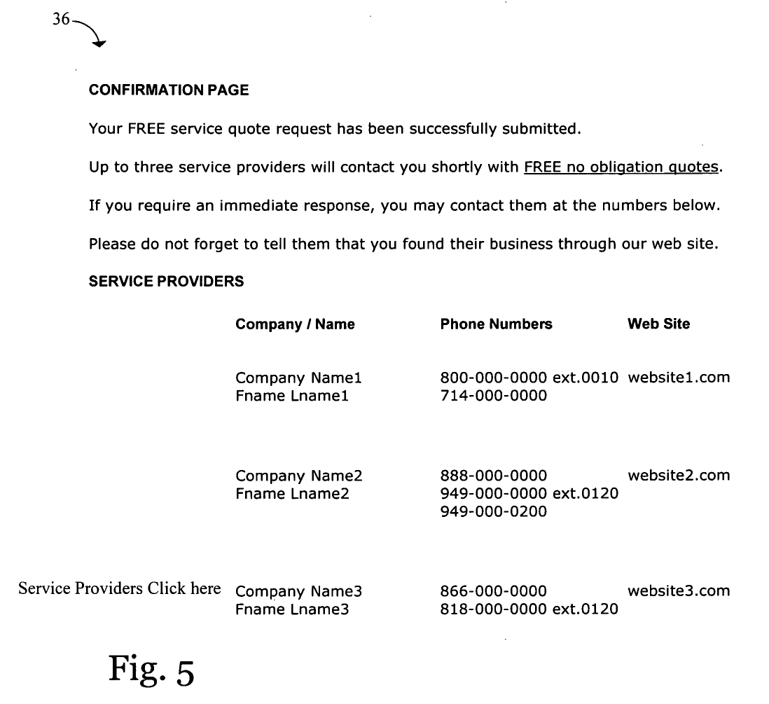

Almost instantaneously, the prospective client may be presented with the CONFIRMATION PAGE 36 shown in FIG. 5 which may list one or more service providers. Accordingly, the elapsed time starting from the moment the prospective client requests a service quote (i.e., the moment the prospective client clicked the “Submit My Service Quote Request” button 34) to the time the prospective client is provided contact information of service providers (i.e., the moment the prospective client is presented with the CONFIRMATION PAGE 36) does not include the time for the clearinghouse 10 to auction the generated lead because the highest bidder of the lead category has already been determined at the time the lead was generated. Additionally, the service provider may be provided with the prospective client's contact information and the parameters of the request (i.e., information inputted in the form 24 shown in FIG. 3) such that the service provider may contact the prospective client to procure his/her business.

In another aspect of the present invention, the clearinghouse 10 may also operate an online auction 14 of lead categories. Each lead category may define general types of leads that service providers are willing to purchase if and when such leads are generated. The lead categories do not contain any leads at the time of the auction 14, and in this sense, service providers are bidding on future leads (i.e., leads to be generated). Service providers may bid on the future leads, and, more particularly, service providers may bid on various lead categories. For example, a service provider may bid on leads for prospective clients desiring to purchase residential homes and/or purchase commercial real estate. If the service provider is the highest winning bidder in these lead categories, then leads that are categorizeable within these categories are directed to such service provider as such leads are generated. Accordingly, the highest bidder of those lead categories may be provided with the prospective client's contact information as well as their buying parameters as entered in the form 24 shown in FIG. 3. Only one service provider is directed to the prospective client if the service provider bids for exclusive leads in the lead categories and wins the auction. Alternatively, two or more service providers may be directed to the prospective clients, as shown in FIG. 5, if the sum total of the bids for non-exclusive leads is greater than the bid for exclusive lead in the lead category.

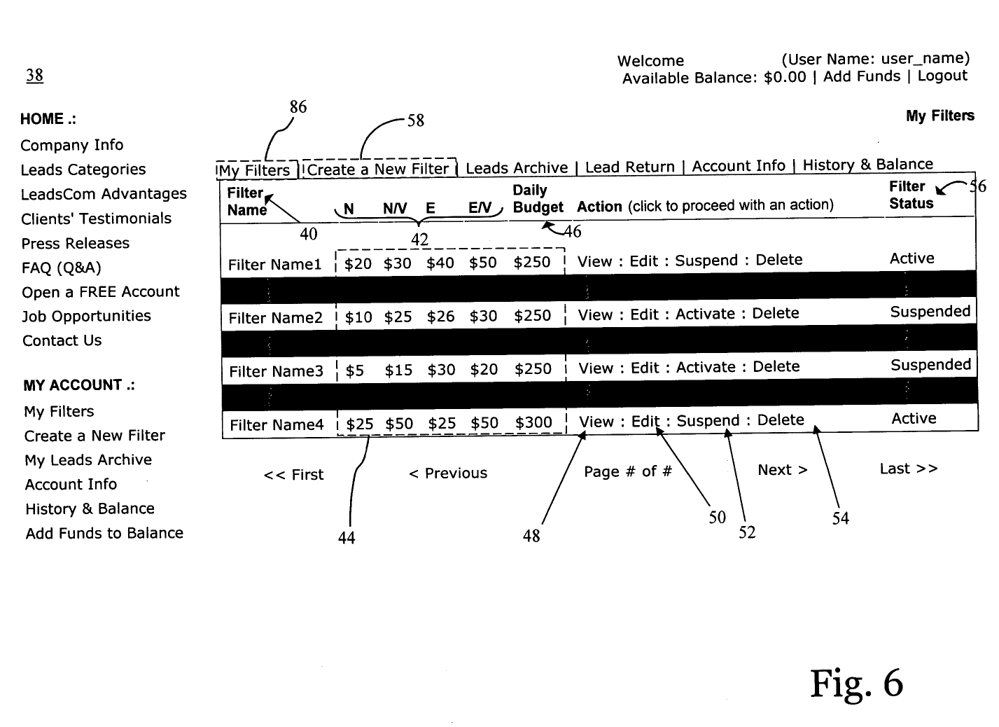

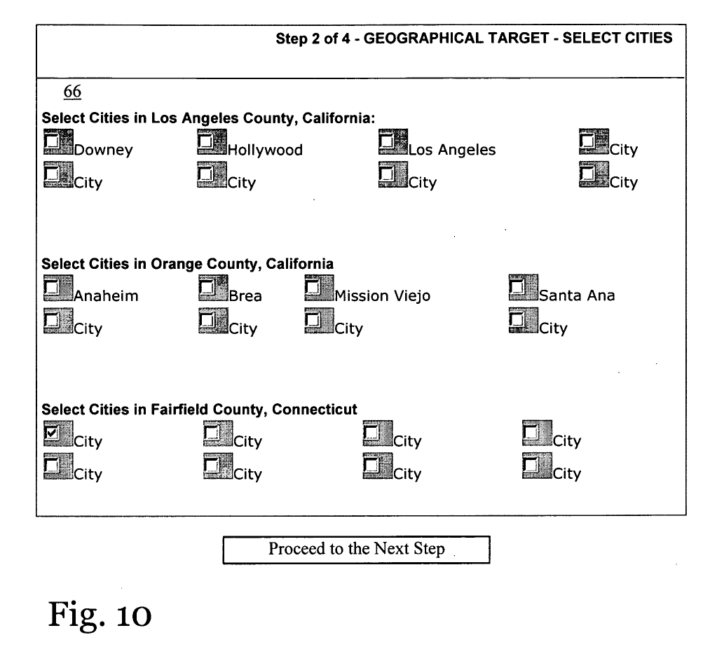

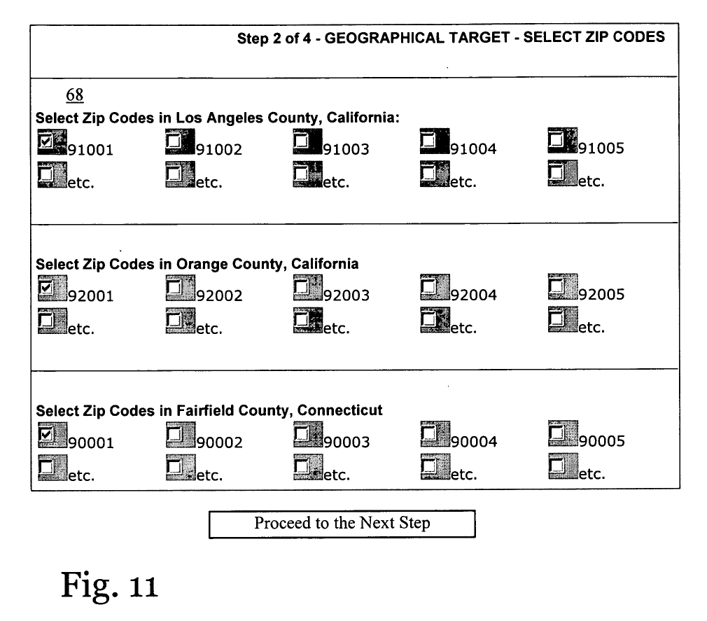

The online auction website is shown in FIGS. 6-13. These figures schematically illustrate the method by which service providers may bid on various lead categories. First, the service providers may register with the clearinghouse 10 to set up an account with the clearinghouse 10. Once the service provider's account is set up, the service provider may be able to log into the clearinghouse's website to view a webpage 38 similar to a webpage shown in FIG. 6, also referred to as the “My Filter” page. As shown in FIG. 6, the service provider is provided with the opportunity to set up various filters (i.e., bids for lead categories) which are the engine (i.e., the parameters) driving the online auction. Each of the filters may be named 40 and the service provider may bid for different qualities of leads 42 within each of the lead categories (e.g., N, N/V, E, E/V, discussed in detail below). If the service provider is the highest winning bidder of the lead category, then their bid price 44 may be shown in green. Alternatively, if the service provider is not the highest winning bidder of the lead category, then their bid price 44 may be shown in red. The service provider may set a daily budget 46 for each of the filters such that once the daily budget has been expended, the filter is suspended without any further action by the service provider. The service provider may also view 48 the particulars of each filter, edit 50 the various parameters of each filter, and suspend 52 or delete 54 each of the filters. Additionally, the filter status 56 is displayed.

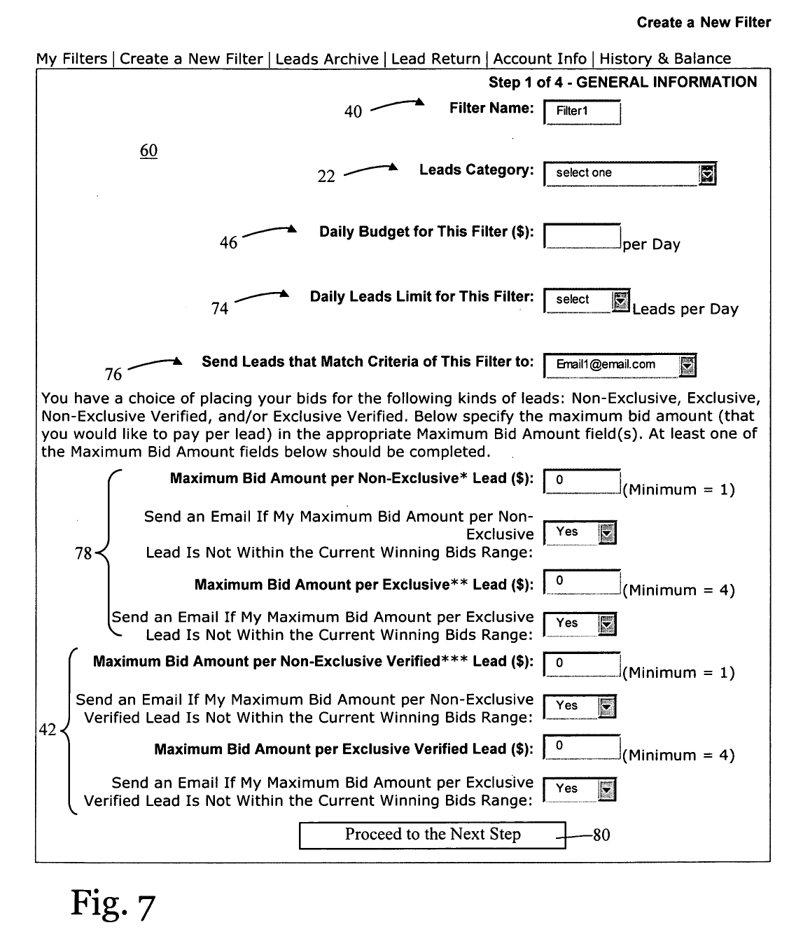

To create a new filter, the service provider may select the “Create a New Filter” option or button 58 which then leads the service provider through the forms 62, 64, 66, 68, 70, 72 shown in FIGS. 7-13. These forms 62, 64, 66, 68, 70, 72 prompt the service provider to define the lead categories 22 which the service provider is willing to bid on and to provide other pertinent information. As shown in FIG. 7, the service provider may name the filter 40. Next, the service provider may provide the general lead category (e.g., real estate, insurance, etc.) 22 which the service provider is willing to bid on. The service provider may also set up the daily budget 46 for this filter such that once the daily budget for the filter is expended, the filter is suspended without further action from the service provider. In other words, the service provider will not be purchasing any leads generated within this category 22 after the daily budget has been reached. Next, the service provider is able to specify the number of leads 74 the service provider is willing to purchase. Next, the service provider is able to specify the manner in which the prospective client's information is to be communicated 76 to the service provider if the service provider is the highest winning bidder for a lead category and a lead categorizeable in the lead category is generated.

The service provider is also given the choice to bid on different qualities of leads 42. By way of example and not limitation, the leads may be verified or non-verified. Verified leads are leads which the clearinghouse 10 contacts to verify the contact information and to determine the seriousness of the intentions of the prospective client to go through with a transaction. Also, the service provider is also given the choice of exclusive or non-exclusive 78 leads. Exclusive leads are leads that will only be sent to the highest winning bidder. Non-exclusive leads are leads that will be sent to multiple service providers such as the three highest bidders. After the service provider has provided the information in the form 60 shown in FIG. 7, the service provider may select the “Proceed to the Next Step” option or button 80.

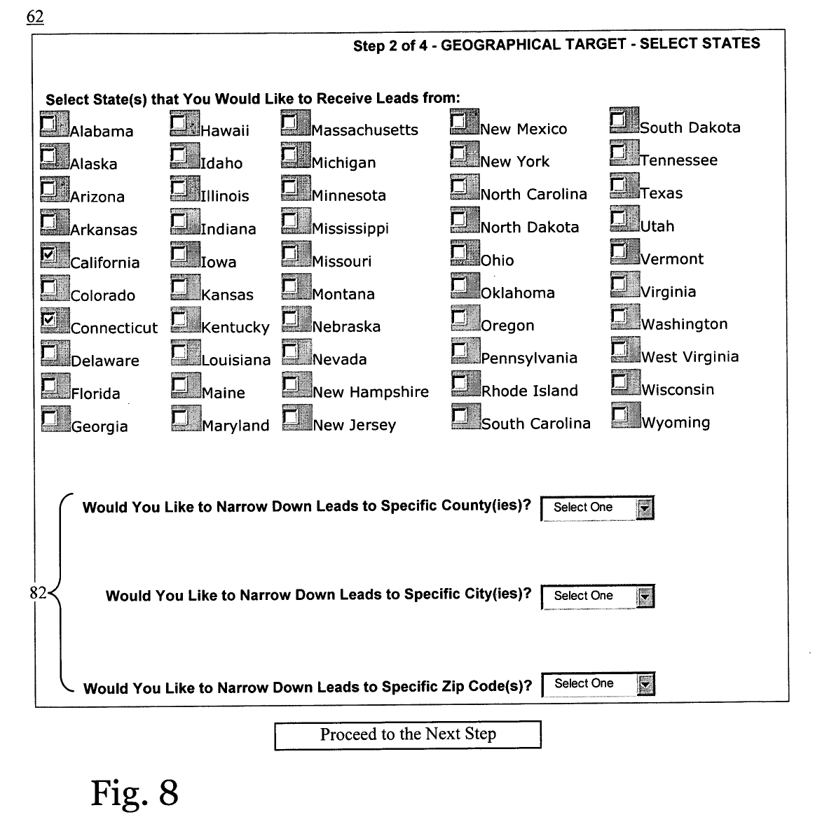

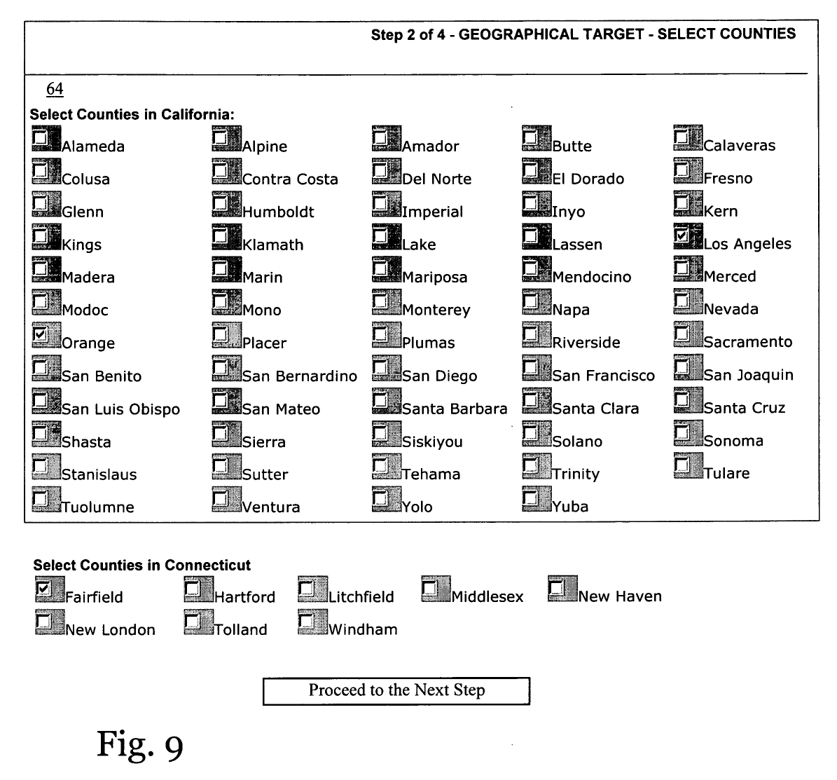

After the service provider has provided the information requested via the form 60 shown in FIG. 7, the service provider may also be requested to narrow the geographical target in which the service provider wishes to market via form 62 (see FIG. 8). For example, the service provider may select one or more states in which to market their services, as shown in FIG. 8. On this form 62, at least one state should be selected by the service provider. For example, as shown in FIG. 8, California and Connecticut were selected. Also, the service provider is provided the option of further narrowing the geographical target with respect to specific counties, specific cities and specific zip codes within the selected state(s) 82. If the service provider wants to further narrow the geographical target with respect to counties, cities and/or zip codes, then forms 64, 66, 68 shown in FIGS. 9-11 may be presented to the service provider and the service provider may narrow the geographical target by selecting the counties, cites and/or zip codes in which the service provider desires to market.

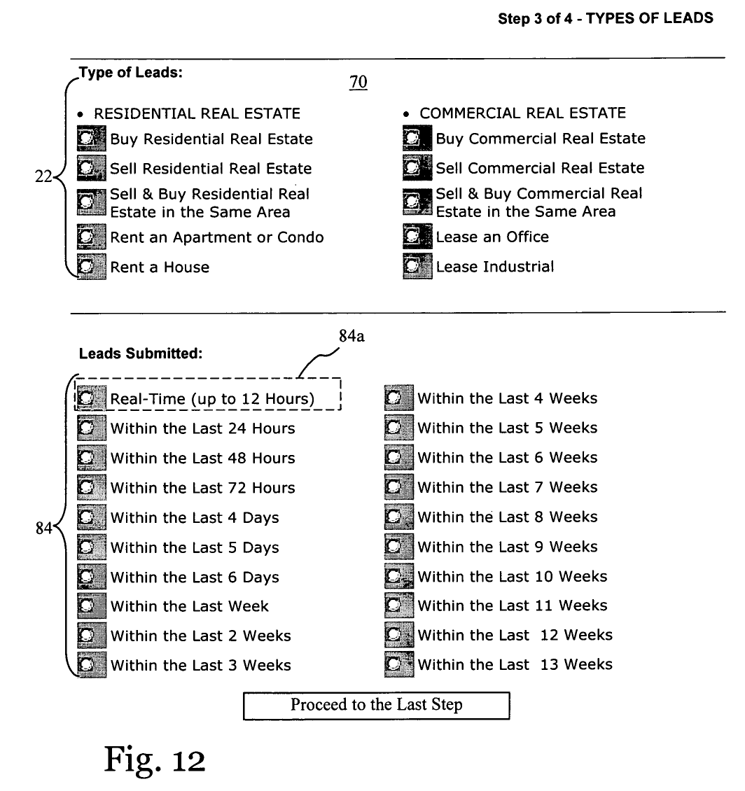

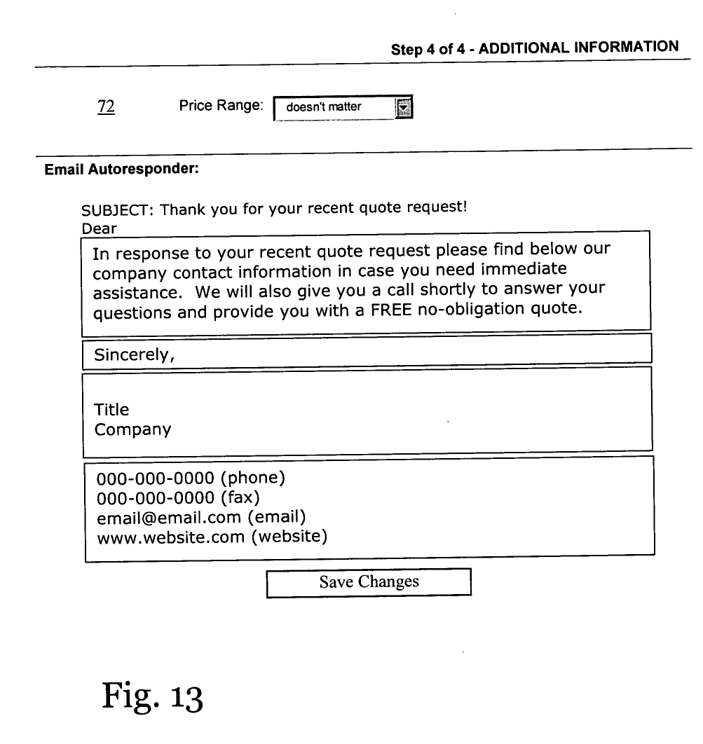

After the service provider has provided the information requested in the forms 60, 62, 64, 66, 68 shown in FIGS. 7-11, the service provider may further narrow the lead category 22 for which the service provider is willing to bid by selecting one or more lead categories, as shown in FIG. 12. Also, the service provider may define the time frame 84 of the lead. If real time 84a is selected by the service provider, then the service provider is indicating that he/she is willing to purchase leads as they are collected (i.e., entered by the prospective client (see FIG. 3)). However, if the service provider selects verified leads 42 (see FIG. 7) and real time 84a, then the service provider may be provided with the prospective client's contact information as the leads are collected and after the lead has been verified. Lastly, the service provider is able to set up an email autoresponder which is emailed to the prospective client if the service provider is the highest bidder, as shown in FIG. 13.

If the parameters of the filter are correct, then the service provider may save the filter by selecting the “Save Changes” option or button 86. Thereafter, the service provider is provided with the filter information or the parameter of the filter, and the service provider may be provided with a notice indicating that “your filter data has been successfully saved.” At this point, the service provider may select the “My Filter” option or button 86 (see FIG. 6) to view whether they are the highest bidder for exclusive leads and/or whether they are one of the top three highest bidders for non exclusive leads.

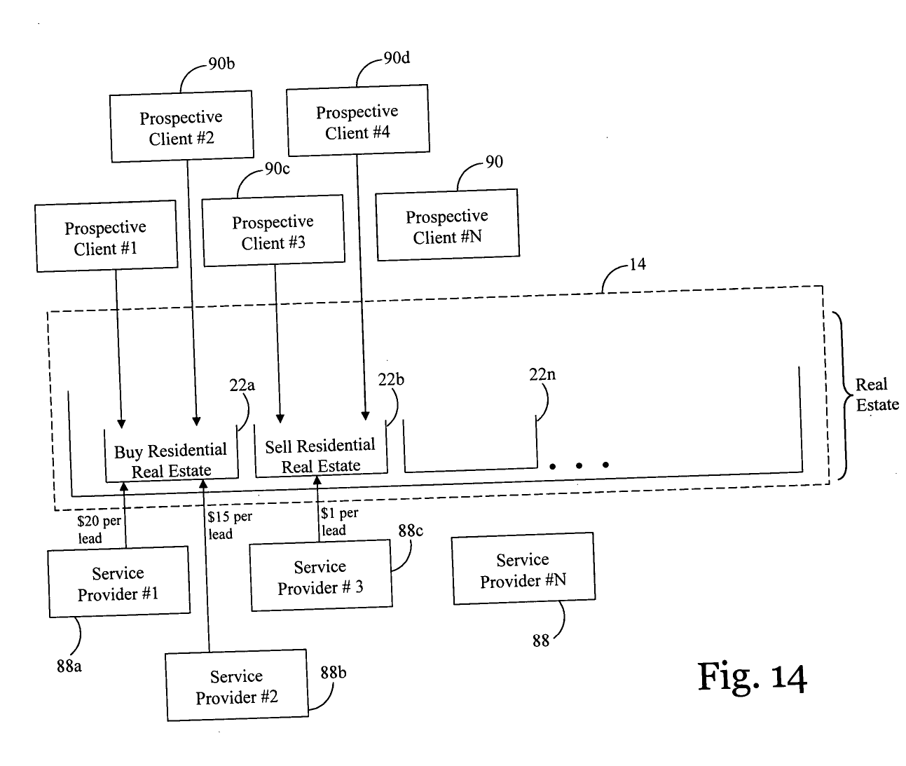

Referring now to FIG. 14, a plurality of service providers may bid on various lead categories 22a, b via the auction 14. By way of example and not limitation, the lead categories may be “Buy Residential Real Estate”, “Sell Residential Real Estate” as well as other defined categories within the broad real estate category. The other more narrowly defined categories are shown in FIG. 2. The plurality of service providers 88a, b, c may bid on the lead category(ies) 22a, b via the method discussed above in relation to FIGS. 6-13. Additionally, as the plurality of service providers 88 are bidding on the various lead categories 22, a plurality of prospective clients a, b, c, d may be submitting their service quote request. (see FIG. 4). The plurality of prospective clients 90 may submit their service quote request via the method discussed above in relation to FIGS. 2-5.

The service providers 88 may bid on various lead categories 22. For example, as shown in FIG. 14, the service providers #1 and #2 88a, b are bidding on the lead category 22a of “Buy Residential Real Estate.” Based on the filter parameters of the various service providers 88, the prospective clients 90 are directed to the service provider(s) 88 and the service provider(s) 88 is directed to the prospective clients 90. For example, prospective client #1 90a submits information categorizeable under the lead category “Buy Residential Real Estate” 22a. If service provider #1 88a selected exclusive leads, then prospective client #1 90a is introduced to service provider #1 88a. However, if service providers #1 and #2 88a, b selected non exclusive leads, then prospective client #1 90 is introduced to both service providers #1 and #2 88a, b. As more prospective clients 90 submit their service quote requests, the daily budget 46 for service provider #1 88a may be exceeded or met. As such, as long as the daily budget 46 for service provider #2 88b has not been exceeded or met, then subsequent prospective clients #N 90 may be directed to service provider #2 88b.

As stated above, if service provider #1 88a selected exclusive leads 78 (see FIGS. 6 and 7) and service provider #2 88b selected nonexclusive leads, then the generated leads of prospective clients #1 and 2 901, b are directed to service provider #1 88a. However, if additional service providers #N 88 selects a non-exclusive bid on the lead category “Buy Residential Real Estate” 22a such that the sum total of their bids for such lead category 22a exceeds service provider #1's bid, then prospective client #1 is directed to service providers #2 and #N 88b, 88. As shown, service providers 88 bid for the lead category 22 based on the parameters of their filters. As such, the fair market value is based on the price these two market participants are willing to pay to purchase leads categorizable within the lead category 22.

In contrast, since the lead category “Sell Residential Real Estate” 22b only has one service provider 88c bidding for it, service provider #3 88c may purchase leads categorizeable under this lead category 22b for only $1 per lead. Hence, the purchase price of the leads may be set by the market participants and not by the clearinghouse 10. This ensures that the lead price is not above or below the fair market value of the lead at the time the lead is generated.

Additional modifications and improvements of the present invention may also be apparent to those of ordinary skill in the art. Thus, the particular combination of parts and steps described and illustrated herein are intended to represent only certain embodiments of the present invention, and is not intended to serve as limitations of alternative devices or methods within the spirit and scope of the invention.

What is claimed is:

1. A method of directing a service provider to a prospective client, the method comprising the steps of:
a) providing a lead category;
b) receiving bids from at least one service providers to purchase leads categorizable under the lead category; and
c) receiving a lead of a prospective client categorizable under the lead category after the receiving bids step.

2. The method of claim 1 wherein the lead category is selected from the group consisting of real estate, mortgages, construction, debt recovery services, business services, insurance services, and automotive.

3. The method of claim 1 wherein the receiving bids step comprises the step of receiving bid parameters from each of the service providers.

4. The method of claim 3 wherein the bid parameters include the bid price and the lead category.

5. The method of claim 1 further comprising the step of comparing the received bids of the service providers to determine the highest bidder.

6. The method of claim 1 wherein the receiving the lead step comprises the steps of receiving contact information on the prospective client and type of service requested.

7. The method of claim 1 further comprising the step of verifying the received lead.

8. The method of claim 1 further comprising the step of routing the received lead to the service providers with the second and third highest bids.

9. The method of claim 1 further comprising the step of routing the received lead to the service provider with the highest bid.

10. The method of claim 1 further comprising the step of routing contact information of the service provider with the highest bid to the prospective client.

11. A method of setting up a filter to bid on leads, the method comprising the steps of:
a) setting up an account with a clearinghouse;
b) submitting bid price parameters to the clearinghouse for a lead category; and
c) submitting a geographical target area to the clearinghouse for the lead category.

12. The method of claim 11 wherein the submitting bid price parameters comprises the step of submitting a daily budget for the filter and at least one of maximum bid amount per non-exclusive lead, maximum bid amount per exclusive lead, maximum bid amount per non-exclusive verified lead, and maximum bid amount per exclusive verified lead.
